(19) United States
(12) Patent Application Publication
(10) Pub. No.: US 2008/0026657 A1
(43) Pub. Date: Jan. 31, 2008

(54) Fabric for manufacture of automotive airbags, airbags and method for making airbags

(76) Inventor: John A. Sollars, LaGrange, GA (US)

Correspondence Address: John E. Vick, Jr.;Legal Department, M-495, P.O. Box 1926, Spartanburg, SC, 29304, US

(21) Appl. No.: 11/825,274

(22) Filed: Jul. 5, 2007

Related U.S. Application Data
(60) Provisional application No. 60/833,449, filed on Jul. 26, 2006.

(51) Int. Cl. B32B 5/22

(52) U.S. Cl. 442/76

(57) ABSTRACT

Airbags are made from fabric blanks that contain two-layer and one-layer regions. Airbags with two-layer areas are commonly “nested” in such fabric blanks for high speed manufacture of many airbags simultaneously. Polymeric coating is applied to both exterior sides of the fabric blank. The fabric blank may be cured (or dried) in ovens to render the coating gas impermeable. Coated airbags in the “nest” are then cut from the fabric blanks into individual airbags. One-piece woven (OPW) airbags may be made in such a process. Certain specific areas of the fabric blanks may be made with specifically engineered weakened yarn weave patterns in defined areas to serve as gas escape points for undesirable gas collection within the two-layer fabric blanks during manufacturing process steps. Such vents are permeable to gas even though the vents are coated during the manufacturing process.

### CROSS REFERENCE TO RELATED APPLICATIONS

This application claims priority to U.S. provisional application Ser. No. 60/833,449 filed in the United States Patent and Trademark Office on Jul. 26, 2006.

### BACKGROUND OF THE INVENTION

Passenger vehicle inflatable protective cushions are known in the industry as “airbags”. Passenger protective systems include at least the following: an impact sensing system, ignition system, a gas producing device, attachment device, system enclosure and an inflatable protective cushion. Airbags may be employed for frontal impact protection, vehicle rollover and side impact protection.

One airbag configuration for use in the protection of vehicle occupants during a side impact collision or rollover event is the “side curtain” configuration. Such airbags may be adjacent the roof line of the vehicle and connected along the door frame.

Certain side curtain airbags must remain inflated for a relatively long period of time. While frontal impact airbags must be inflated for only a fraction of a second (a brief moment when the passenger strikes the cushion), some side curtain airbags must remain inflated for much longer periods of time to protect occupants during vehicle rollover events. To achieve such inflation properties, it is sometimes desirable to provide coatings upon a textile or fabric substrate to achieve a side curtain airbag having an air-tight seal. Coatings have been developed and used to render such fabric substrates air impermeable for this purpose. Silicone polymers and other elastomers are commonly used for coating airbags.

One common method of manufacture of such airbags is to make a one piece woven structure that defines the inflatable airbag. That structure may have areas of two or more layers (for inflation) and areas of one layer around the inflatable two layer areas that acts as one or more “seams” to contain the inflation gas. The entire structure may also contain areas that are not to be inflated. These non-inflated areas can be one or two layers, but they are not in communication with the inflating gas. One layer areas and two layer areas commonly are defined on a fabric by the weaving method used to create the fabric, such as by Jacquard weaving. One piece woven airbags are made by interweaving and controlling the shape of the airbag using a loom having programming means, such as a Jacquard system. A Jacquard system uses a computer controlled process or a series of punched cards wherein each card perforation controls the action of a single warp thread for the passage of a single pick. A predefined airbag configuration may be applied in a computer controlled process, resulting in the application of warp yarns and weft yarns in the exact configuration that is desired for the textile structure.

Yarn shifting has proven to be a significant problem for airbag cushion design. When a sewn seam is placed under stress, a naturally lubricating silicone coating on the yarn may allow the yarn undesirably to shift out of position. This shifting can lead to leakage of the inflating gas through new pores formed from the shifting yarns, or, in drastic cases, this may even cause the seam to fail. Since the airbag must retain its integrity during a collision event to sufficiently protect the driver or passenger, there is a great need to provide coatings which provide both effective permeability characteristics and sufficient restriction of yarn shifting for the airbag to function properly. In airbag manufacturing, it has been common to provide tight woven fabric that will resist yarn shifting. Further, it has been the practice in the industry to provide coatings that will render the fabric essentially air/gas impermeable. The teachings in the airbag manufacturing industry, therefore, have suggested against procedures during weaving that would cause yarns to shift out of position. In fact, quality efforts often focus on providing a completely tight and gas impermeable airbag, with highly intertwined woven materials that are preferred in the industry.

During manufacturing of airbags, various challenges are presented. A viscous coating maybe applied to one side of an elongated fabric blank, followed by heating. Then, the fabric blank receives a coating on the opposite (second) side, following by heating once more. The purpose of the heating steps is to cure (or harden) the coating at relatively high temperatures. This heating step causes the evolution of gas and vapor from the coating, called “out gassing”. This undesirable gas generation in a one piece woven fabric that has coating applied to both sides results in bulging of the fabric blank in certain isolated two-layer areas of the blank. The coating is gas impermeable, which traps the gas within the airbag fabric blank. This bulging may cause significant processing difficulties. Trapped gas may undesirably inflate the space inside and between the layers of the nested airbags upon the fabric, which makes processing difficult. This gas generation and subsequent inflation of the fabric may result in in an undesirable creasing of the fabric as the fabric travels around rollers, and can create problems in obtaining a uniform layer in the coating process. This effect may be worsened in situations in which there are multiple airbags upon the fabric blank (i.e. nested airbags), as it may inhibit the gas from traveling between the two layers to the selvage area of the fabric, where the gas might otherwise escape. Trapped gas is a significant airbag manufacturing problem for coated airbags.

FIG. 1A shows a typical conventional prior art fabric blank 10 having nested airbags 12a-f. FIG. 1B shows a perspective view of the fabric blank 10, wherein undesirable bulging gas collection areas 14a-f may be seen on the blank. These bulging gas collection areas cause processing difficulties in the manufacture of airbags.

The invention herein is directed at methods and apparatus for minimizing or eliminating gas collection problems in airbag manufacturing. Improved airbag fabric and manufacturing methods are disclosed that are adapted for minimizing this problem.

### BRIEF DESCRIPTION OF THE DRAWINGS

A full and enabling disclosure of this invention, including the best mode shown to one of ordinary skill in the art, is set forth in this specification. The following Figures illustrate the invention:

FIGS. 1A-1C show the gas collection and bulging problems that may be solved by the invention;

FIG. 2 shows a schematic flowchart of the steps in the practice of the method of the invention;

FIGS. 2A-2B illustrate a coating blade application of coating upon a gas vent in a fabric in which the yarns on the surface of the vent run parallel to the blade (fill yarns);

FIGS. 2C-2D illustrate a coating blade application of coating upon a gas vent in the fabric in which the yarns on the surface of the vent run perpendicular to the blade (warp yarns);

FIG. 3 shows potential locations for vents upon a fabric with nested airbags, while FIG. 3A shows an airbag that has been cut from the vented fabric shown in FIG. 3;

FIG. 4 is a weave pattern for two layers of plain weave;

FIGS. 5A-5B are the weave patterns for two embodiments of the invention which float either all the warp or fill yarns on the top surface of the fabric, on both layers of fabric, in the region of gas vents;

FIG. 5C is a cross-section of an embodiment of the invention as shown in FIG. 5A, in which the warp yarns of both layers are floated to the top surface;

FIG. 5D shows a cross-section of the embodiment of the invention shown in FIG. 5B in which the warp yarns are floated from both top and bottom layers to the bottom surface;

FIGS. 6A-6B more embodiments of the invention which floats either all the warp or all of the fill yarns in the top layer of the fabric in the region of gas vents, while the bottom layer of fabric retains a plain weave with no floats;

FIG. 6C is a cross-section of the embodiment of FIG. 6B in which the filling yarns are floated from the top layer to the top surface;

FIGS. 7A-7B (and FIG. 7C) show more embodiments of the invention which floats either the warp or fill yarns in the bottom layer of fabric for placement on vents, while the top layer of fabric retains a plain weave with no floats, and FIG. 7C is a cross-sectional view that corresponds to the embodiment of FIG. 7B;

FIG. 8 shows an embodiment of the invention in which the weave is designed to float the filling yarn from the top layer of the fabric on the top surface of the fabric at the vent region; and

FIG. 8A illustrates the embodiment of FIG. 8 in which the filling yarns are floated from both fabric layers (respectively) to the top and bottom exterior surfaces, resulting in an effective vent that is capable of passing undesirable gas out of the two layer airbag fabric structure.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

In the practice of the invention, it has been discovered that one may alleviate gas bulging and gas collection problems in the course of two-layer airbag manufacture. The invention is directed to placement of gas vents in certain specific areas of the airbag fabric. The warp and fill yarns in the vents are either not interlaced (woven) together, or are woven in a loose pattern into strategically chosen areas of the design layout to allow disruption in the application of the coating layer or breaks to be created in the coating layer after application. This may undesirably cause trapped gas to escape. The vents may be placed in an area of the fabric blank in between the usable air bag portions, thus not interfering with the airbag performance after it is cut from the base fabric. It is possible to “float” all or some of the warp yarns or filling yarns in the vent areas without interweaving in the top, bottom, or both top and bottom layers of the fabric. This vented area allows undesirable gas to escape, even after viscous thick coatings are applied, which is unexpected and not predictable.

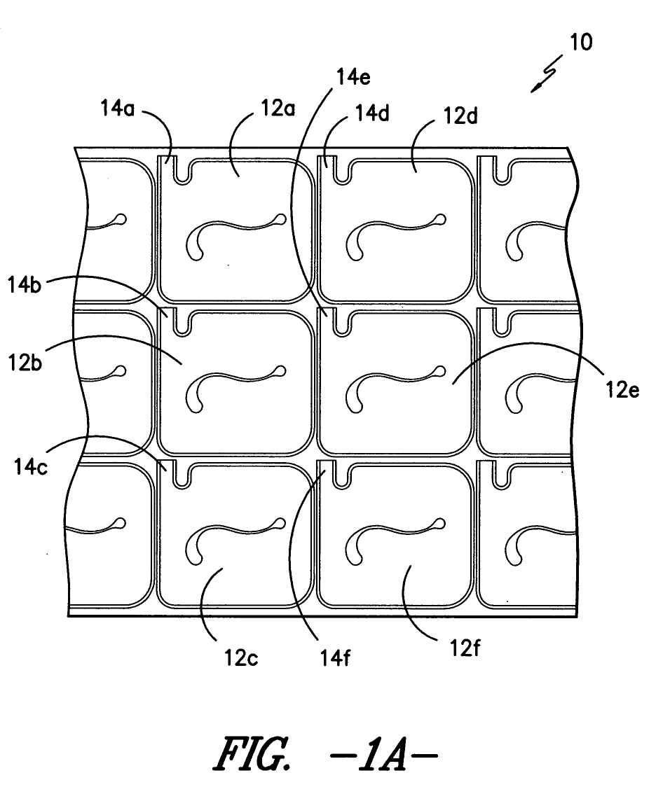

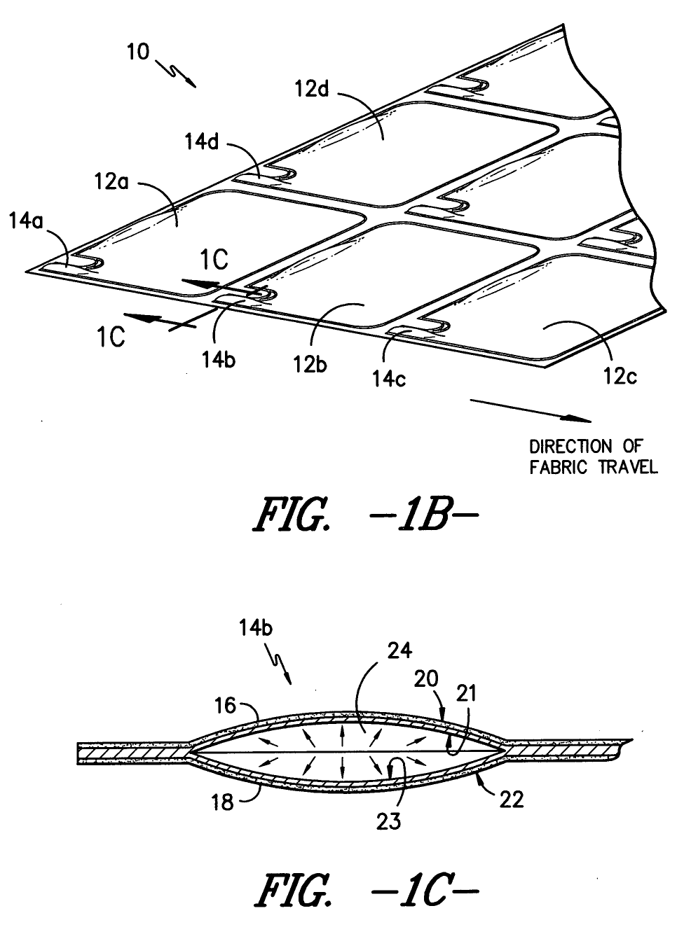

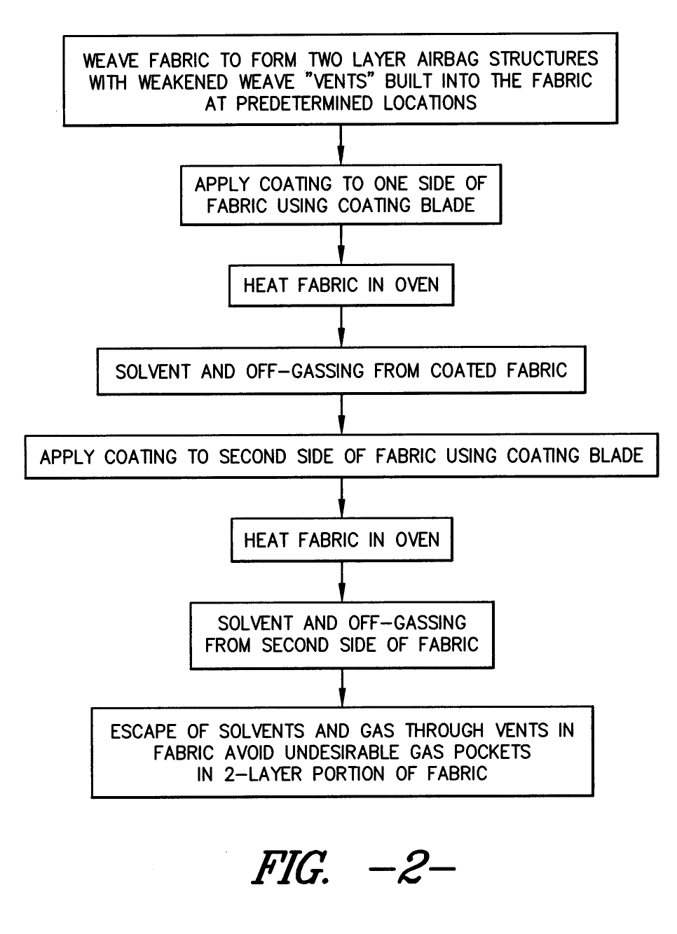

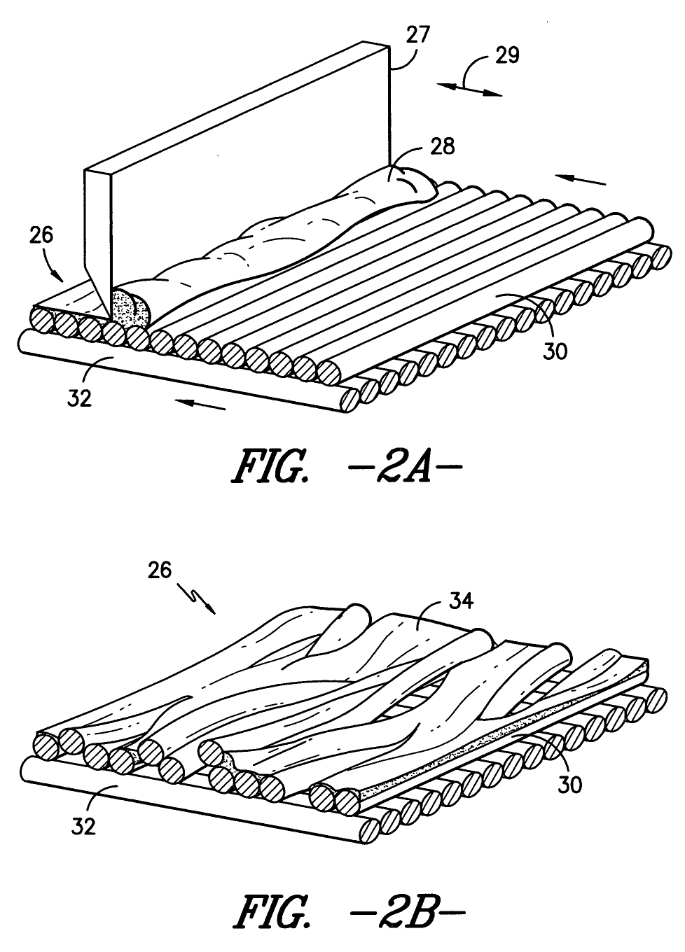

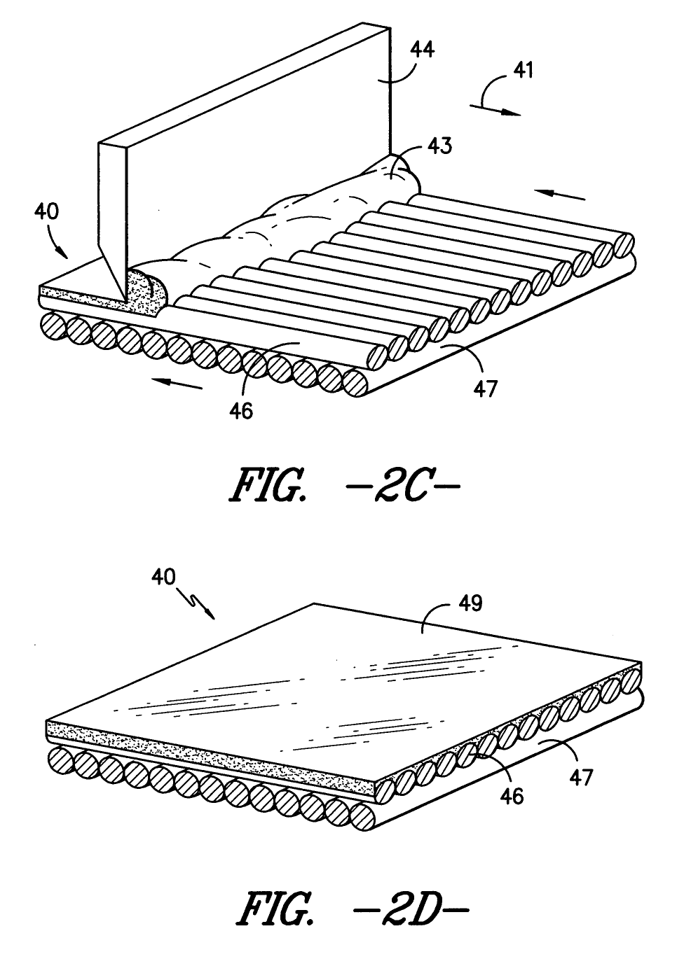

FIG. 1A shows an non-vented fabric blank 10 comprised of nested airbags 12a-f. Mouth areas 14a-f of the airbags 12a-f are designed to receive inflation conduits when the airbags are in use in automobiles (not shown). FIG. 1B shows a perspective view of the fabric blank 10 which shows gas undesirably collecting in the mouth areas 14a-f. FIG. 1C shows a cross-section of the mouth area 14b, having top layer 16 with an exterior surface 20 and an interior surface 21. Bottom layer 18 is defined by interior surface 23 and exterior surface 22. Gas 24 causes the separation of top layer 16 from bottom layer 18. The invention described herein minimizes this gas collection problem, as further shown in FIGS. 2-3.

In the practice of the invention, a coated fabric for use in manufacture of airbags is provided. The fabric is a woven substrate that is substantially gas impermeable. The woven substrate is integrally woven with portions of one layer and other portions that are two layers. The two layer regions have top layer and bottom layers, with a defined space between the layers that is adapted for gaseous inflation, the two layer regions being defined on the coated fabric in a repetitive pattern of perimeters of woven airbags. The woven substrate further comprises vents in the two layer regions. At least some of the vents are comprised of a weakened weave pattern wherein at least one of the airbag vents has an applied non-uniform coating. The coating facilitates gaseous transfer across a weakened weave pattern of the vent, and at least one of the vents is partially permeable to gas. Once the fabric has been manufactured, the airbags may be cut or removed along the perimeter of each airbag, forming one-piece integrally woven airbags having inflatable and air impermeable two piece regions within the airbags. The vents remain on the discarded portion of the woven substrate.

The coated fabric may provide two-layer regions of the woven substrate having yarns. The polymeric coating may be applied to the vents in various ways, but it is common to do so with a mechanical device such as a blade. The vent is desirably made of substantially disoriented yarns and a non-uniform polymeric coating upon the substantially disoriented yarns. The vent is at least partially permeable to gas, even after being coated. In the work leading to the invention, it was discovered that it is possible to increase yarn disorientation and to increase the gas permeability of the vent by selection of the weave pattern employed, and by disruptive mechanical forces applied during application of the viscous coating. It was not predictable that these weave patterns could alleviate the problem of gas collection, especially since the vents are coated with a viscous impermeable barrier coating.

The coated fabric includes a weakened weave pattern with warp or fill yarns that are floated to the exterior surface of the top or bottom layers in the region of the vent. The position of the yarns may facilitate the shifting or separation of yarns in the vent upon application of gas pressure, resulting in a vent that is at least partially permeable to gas. The yarns on the surface of said vent may be oriented generally perpendicular to the blade such that movement of the blade over the yarns results in a deposition of coating upon said vent in a substantially non-uniform manner. This provides for gas permeability of the vent.

A method for making an automotive airbag fabric is shown by way of the invention. A woven substrate has multiple two-layer regions, said regions each comprising at least a top layer and a bottom layer. The top layer comprises an interior surface and an exterior surface, further wherein the bottom layer comprises an interior surface and an exterior surface. The exterior surfaces of the top and bottom layers comprise interwoven yarns. The two-layer regions of the woven substrate further comprise at least one vent in a predetermined location upon the exterior surface of the top or bottom layer, the vent being formed of a weakened weave pattern of yarns. Coating material is applied to the exterior surfaces of the top and bottom layers of the woven substrate. The method optionally may include cutting the coated airbag fabric in predetermined locations to form woven airbags.

FIG. 2 is a schematic flow diagram that shows the steps in the practice of the method of the invention. It is possible to weave fabric to form two layer airbag structures with weakened weave vents built into the fabric at predetermined locations (vents described herein in connection with FIGS. 2A-8A; see also FIG. 3). Even after coating, it has been found that such vents may allow air permeation through the vents, which is unexpected. A coating is applied to one side of the fabric using a coating blade, followed by heating in an oven. Solvent off-gassing emanates from the coated fabric, and coating then is applied to the second side of the fabric using the coating blade. Coating is applied in the warp direction along the fabric as the fabric moves along a conveyor (not shown). The coating is heated in an oven, and solvent off-gassing occurs. The escape of solvents and/or gases through the vents in the fabric of the invention avoids undesirable gas pockets (see FIGS. 1B-1C) in the two layer portions of the fabric.

Ethylene-methyl acrylate or ethylene-vinyl acetate copolymers may be employed with a silicone copolymer. For purposes of this invention, any coating capable of forming air impermeability to the majority of the fabric may be used, including for example coatings described in U.S. Pat. Nos. 7,132,170 and 6,846,004 to Parker. In the invention, weakened weave patterns have been discovered that, when combined with polymeric coatings, unexpectedly provide effective gas permeable vents in the fabric at predetermined locations.

FIG. 2A shows a vent 26, a structure that may be designed with a weave pattern that facilitates relative weakness. FIG. 2A shows an embodiment in which the weave pattern in the vent 26 uses weft yarns 30 proceeding generally perpendicular to warp direction 29, adjacent the exterior surface of the vent 26. Beneath the weft yarns 30 are warp yarns 32. During fabric blank manufacture, the weakened weave pattern then receives coating blade 27 which applies polymeric coating 28 to vent 26.

FIG. 2B reveals the non-uniform discontinuous coating that results on the vent 26 from the action of the blade 27 moving across weft yarns 30, in which the weft yarns 30 run generally parallel to the blade. This movement causes disorientation of the weft yarns 30, resulting in the less than complete coverage by coating 28. This manner of forming the vent 26 is desirable. It is unexpected that the coating 28 (which conventionally is adapted for rendering the fabric as impermeable as possible) when applied in this manner to weft yarns 30 results in non-uniform discontinuous coating 34 and an effective gas permeable vent 26.

In FIGS. 2C-2D, another manner of making a vent 40 is disclosed. Warp yarns 46 in the warp direction 41 are on the exterior of the vent 40, while weft yarns 47 are beneath. Blade 44 applies viscous polymeric coating 43 to form a more somewhat more uniform coating 49 that is less gas permeable as compared to vent 26 of FIGS. 2A-2B. It appears that the movement of the blade 44 along the length of warp yarns 46 (where the warp yarns 46 are generally perpendicular to the blade 44) results in less disruption of the continuous coating 49. Although the vent 40 may be somewhat gas permeable, and may function to relieve gas pressure from the airbag structure to which it is attached, it is not as gas permeable as the example of FIGS. 2A-2B. Therefore, this structure is not believed to be as desirable for purposes of venting gas, but still may be useful in practice of the invention.

FIG. 3 reveals numerous vents (vents 50-76) as examples of locations upon the fabric blank 10 that desirably may be vented or ported for gas relief. This results in a higher quality fabric blank 10 with less manufacturing defects upon the fabric blank 10, and consequently less defects in the finished two layer airbags. By avoiding gas build-up in the two layer areas of the fabric, there are less manufacturing problems. That is, the gas collection bulges cause damage to the fabric during manufacture. Further, coatings do not apply as well or evenly to fabrics that have bulges and/or unusual collection points for gas. Once the fabric blank 10 is manufactured successfully, then the fabric blank 10 can be cut in a high speed cutting operation, which leaves individual airbags 78 (see FIGS. 3 and 3A), which are cut from the fabric blank 10 in exact and predetermined locations, and which are free from vents 50-76. The airbags 78 are cut along perimeter 78a, shown for example in FIG. 3A. The waste portions of the fabric blank 10 contain the vents 50-76, as the vents are needed only during manufacturing of the fabric blank 10. The vents 50-76 are located on the fabric blank 10 in two layer regions that are outside the defined perimeter patterns (i.e. outside of perimeter 78a of FIG. 3A) of the respective airbags.

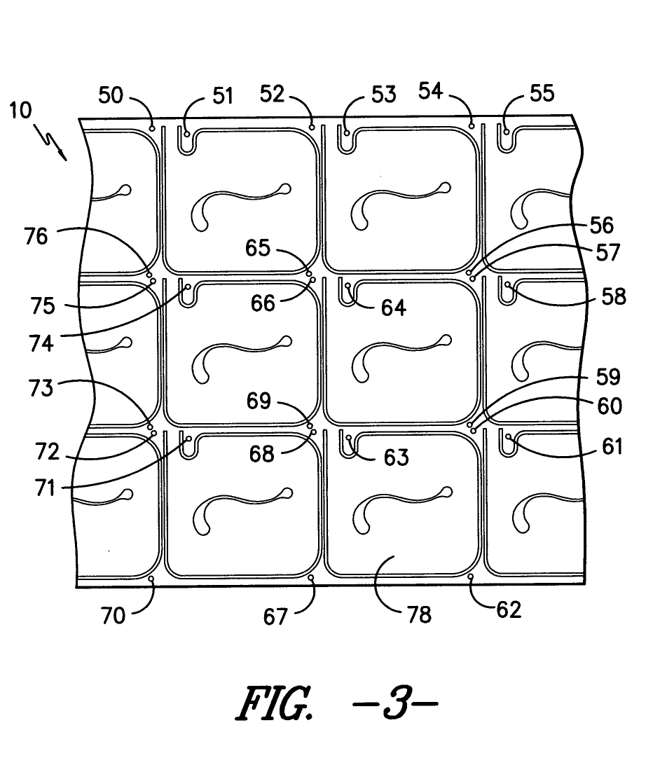

FIG. 4 shows one manner of achieving a weave pattern in a two layer fabric. The pattern shown will produce two layers of plain weave and is used as a reference for other vent weaves shown herein.

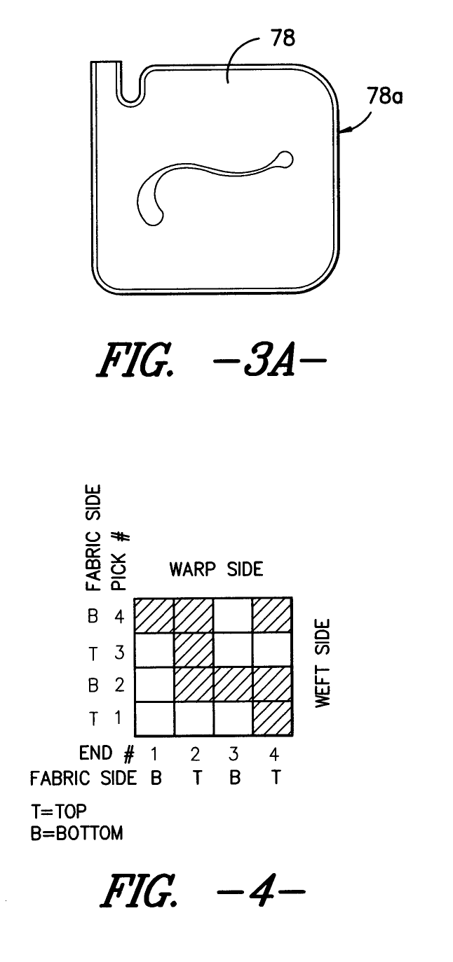

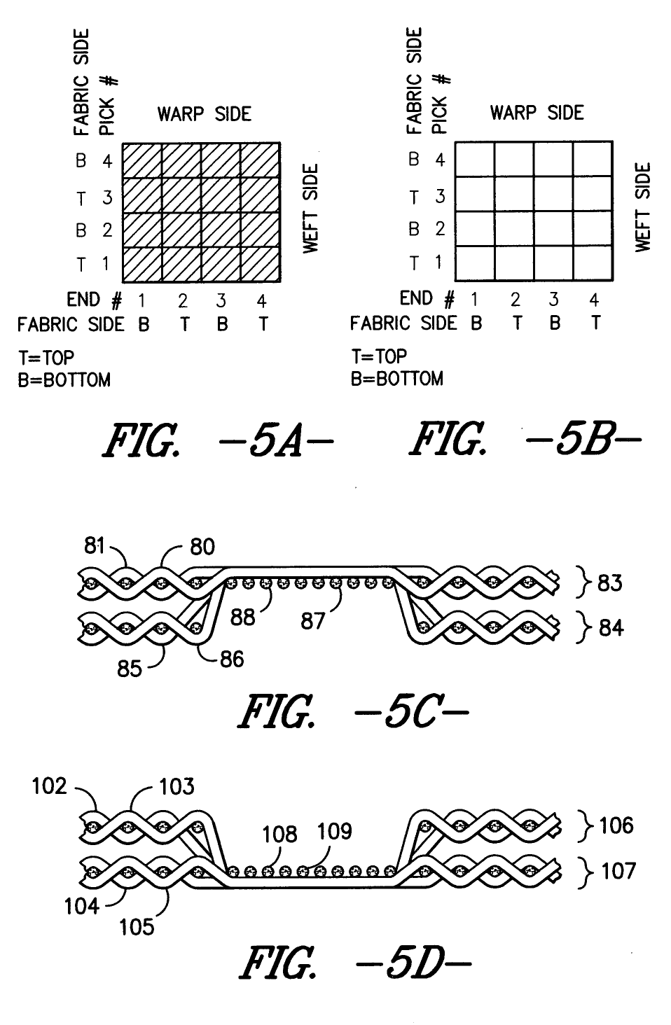

For the discussion herein, the “top layer” refers to the uppermost layer of the two layer portion of the airbag fabric as it is being initially woven on the loom, while the bottom layer likewise refers to the lowermost layer of the two layer portion of the airbag fabric. Even though subsequent processing steps of the fabric may alternate which surface of the fabric is uppermost, at any given step, those skilled in the art of processing one piece woven fabric structure are familiar with techniques to identify which side of the fabric was uppermost at the time of weaving. For example, a one piece woven airbag may be employed, and the FIGS. 5A through 8A show various embodiments of possible gas vent configurations in the practice of the invention.

FIG. 5A and FIG. 5B show weaves that will float either all of the warp or fill yarns from both layers of the fabric on the top surface of the fabric. FIG. 5A specifically shows floating the warp yarns from both layers on the top surface. FIG. 5B shows floating fill yarns from both layers on the top surface. FIG. 5C shows such an embodiment having warp yarns 80 and 81. Top layer 83 is seen above bottom layer 84. Fill yarns 87-88 are shown in cross-section, and warp yarns 85-86 also may be seen in the FIG. 5C. FIG. 5D shows an embodiment of the invention in which the warp yarns are floated from both top and bottom layers to the bottom surface. This shows one example of such a weave structure in which top layer 106 and bottom layer 107 are seen. Warp yarns 102, 103 are floated down to the bottom layer, which contains warp yarns 104 and 105. Filling yarns 108 and 109 are shown in cross-section in the region of the vent.

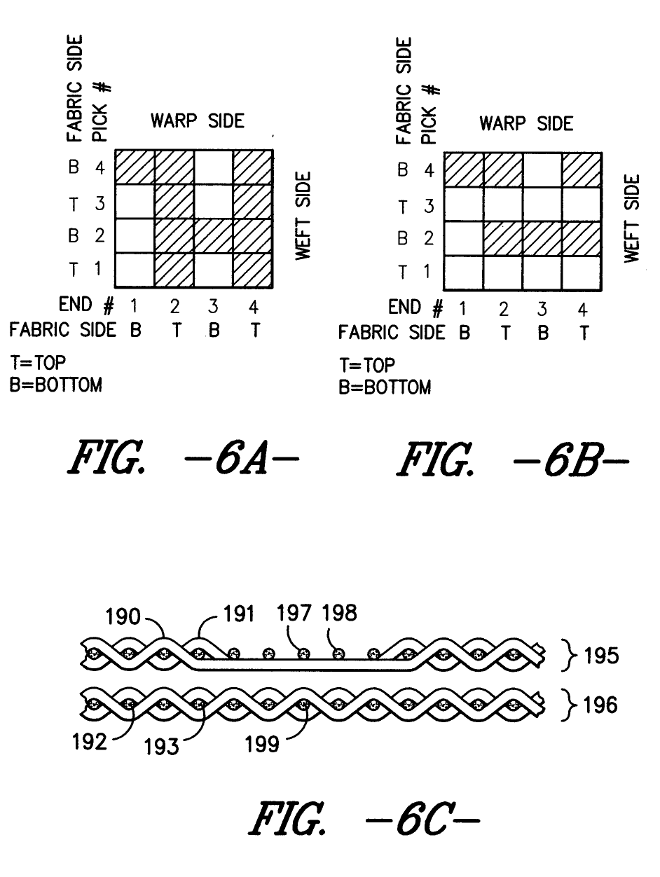

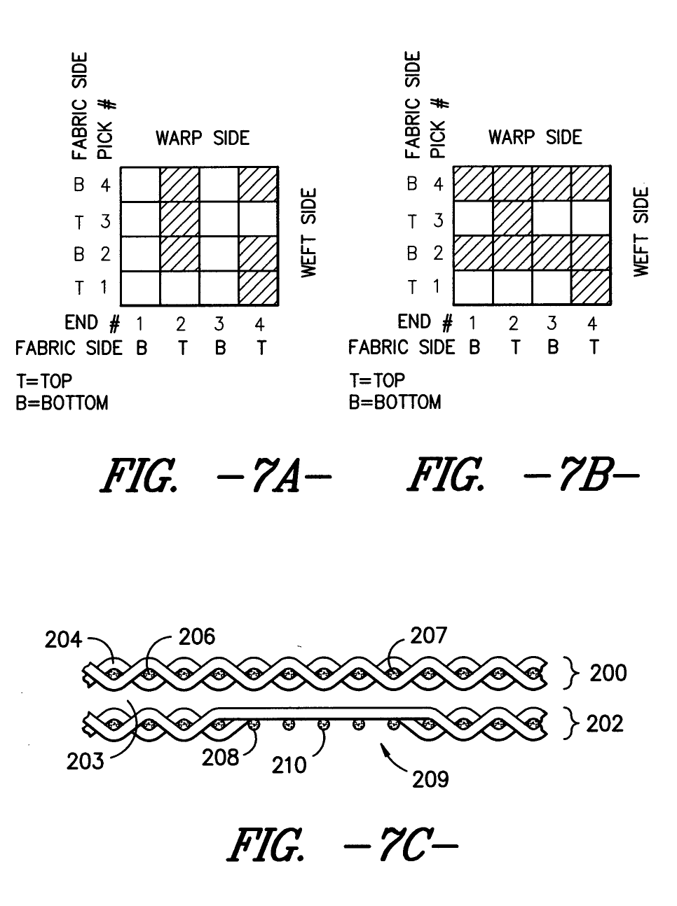

FIGS. 6A and 6B illustrate weaves that will float either the warp or the fill yarns from the top layer of the fabric. In this embodiment of the invention, it is possible to float them on the top surface of the top layer of fabric. The bottom layer of fabric may remain a plain weave with no floats. FIG. 6A shows floating warp yarns from a top layer on the top surface. FIG. 6B is directed to floating fill yarns from the top layer on the top surface. FIG. 6C is one example showing top layer 195, bottom layer 196, and warp yarns 190-191. Fill yarns 192, 193 and 199 may be seen in FIG. 6C in cross-section. Also, fill yarns in the top layer 195 are shown as fill yarns 197-198.

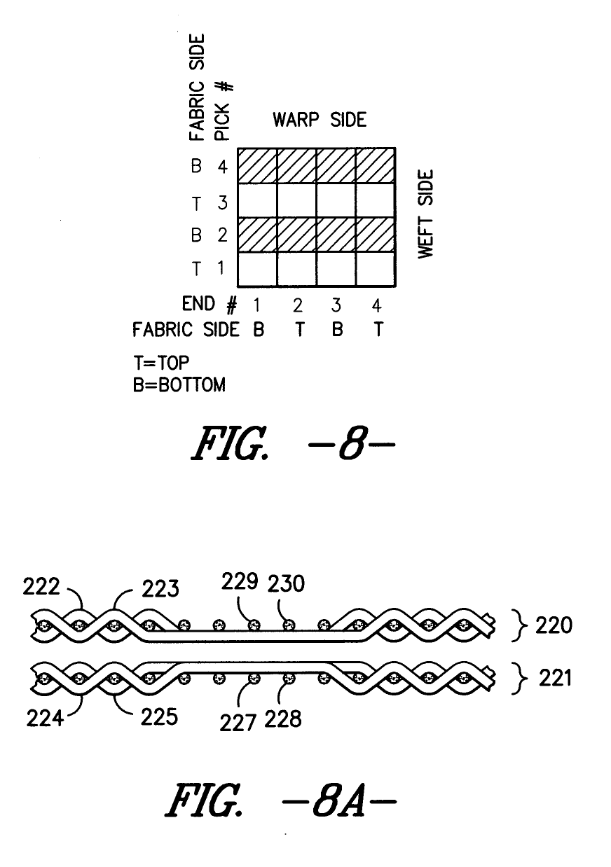

FIGS. 7A and 7B are directed to weaves that will float either the warp or the fill yarns from the bottom layer of fabric, and float them on the bottom surface of the bottom layer of fabric. The top layer of fabric will may be a plain weave with no floats. FIG. 7A provides for floating warp yarns from the bottom layer on the bottom surface. FIG. 7B shows an embodiment which floats fill yarns from the bottom layer on the bottom surface. FIG. 7C is a cross-section that corresponds to FIG. 7B. Top layer 200 and bottom layer 202 are separated by inflatable space 203. Warp yarns 204 and 206 are in the top layer 200. Weft yarn 207 is seen in cross-section in the top layer 200. This embodiment of the invention floats either the warp or fill yarns in the bottom layer 202 of fabric for placement on vents, while the top layer 200 of fabric retains a plain weave with no floats. A vent 209 is formed in the bottom layer 202, where weft yarns 208 and 210 are seen in cross-section.

FIG. 8 shows an embodiment in which the filling yarn is floated from the top layer of fabric on the top surface of the fabric, along with filling yarns from the bottom layer on the bottom surface of the fabric. This weave may have advantages due to the coating blade desirably “raking back” and disturbing the position of the filling yarns as shown herein in FIGS. 2A-2B, for example. By presenting the yarns in position for perpendicular orientation as compared to the coating blade 27, the chances of the coating blade contact breaking through the coating film formed over the float areas is increased, resulting in disoriented yarns on the surface, and desirable vents in the airbag fabric two layer areas. In this embodiment, the fill yarns are floated from the top layer to the top surface, and fill yarns are floated from the bottom layer on the bottom surface. One example of that is shown in FIG. 8A. In that Figure, top layer 220 and bottom layer 221 are illustrated, with warp yarns 222, 223 in the top layer 220 and warp yarns 224, 225 in the bottom layer. Weft yarns (filling yarns) 227-230 may be seen in cross section. Thus, in this way, a vent is provided on both the top and bottom layers 220-221. This embodiment has been shown to be highly effective in providing a gas permeable vent that avoids undesirable gas collection points when used in airbag fabric of two layers.

It is understood by one of ordinary skill in the art that the present discussion is a description of exemplary embodiments only, and is not intended as limiting the broader aspects of the present invention. Certainly, other weave configurations and other methods of coating to provide vents could be contemplated within the scope of the invention. This may include, but is not limited to, “upside down”, “offset”, “mirrored”, or “sideways” versions of the weave diagrams shown in this specification. The invention is shown by example in the appended claims.

1. A coated fabric for use in the manufacture of automotive airbags, the coated fabric being comprised of:
(a) a woven substrate having a polymeric coating that is substantially gas impermeable, the woven substrate having integrally woven one layer regions and two-layer regions, the two layer regions each comprising at least a top layer and a bottom layer, the top and bottom layers defining a space between said layers that is adapted for gaseous inflation, the two layer regions being defined on said coated fabric in a repetitive pattern of perimeters of multiple woven airbags;
(b) the woven substrate further comprising multiple vents in predetermined locations upon the two layer regions, at least one of the vents being formed of a weakened weave pattern, the vents being located on the woven substrate in two layer regions outside the defined perimeter pattern of the airbags, wherein at least one of the vents has applied thereon a non-uniform polymeric coating, wherein the coating facilitates gaseous transfer across the weakened weave pattern of the vent, at least one of the vents being partially permeable to gas.

2. The coated fabric of claim 1 wherein the two-layer region of the woven substrate is comprised of yarns, further wherein the vent receives the polymeric coating in a process comprising the step of applying the polymeric coating upon yarns of said vent with a blade.

3. The coated fabric of claim 1 wherein the weakened weave pattern upon the vent comprises warp or fill yarns that are floated to the exterior surface of the top or bottom layer in the region of the vent.

4. The coated fabric of claim 3 wherein said vent is comprised of yarns in the weakened weave pattern, wherein the position of the yarns facilitates the shifting or separation of yarns in the vent upon application of gas pressure, the vent being at least partially permeable to gas.

5. The coated fabric of claim 2 wherein the yarns upon the surface of the vent are oriented generally substantially perpendicular to the direction of the fabric travel.

6. An airbag cut from the coated fabric of claim 1.

7. A method for making an automotive airbag fabric, comprising:
(a) providing a woven substrate, the woven substrate having one layer regions and multiple two-layer regions, said regions each comprising at least a top layer and a bottom layer, wherein said top layer comprises an interior surface and an exterior surface, further wherein the bottom layer comprises an interior surface and an exterior surface, the exterior surfaces of the top and bottom layers consisting essentially of interwoven yarns;
(b) the two-layer regions of the woven substrate further defining the perimeter of multiple air bag structures, said regions comprising at least one vent in a predetermined location upon the exterior surface of the top or bottom layer, the vent being formed of a weakened weave pattern of yarns;
(c) providing a coating material;
(d) applying the coating material to the exterior surfaces of the top and bottom layers of the woven substrate, thereby coating said vent to form a coated vent; and
(e) wherein the coated vent of the coated airbag fabric is located outside the perimeters of the multiple airbag structures and is at least partially gas permeable.

8. The method of claim 7 additionally comprising the step (f):
(f) cutting the coated airbag fabric to form at least one coated woven airbag.

9. The method of claim 7 wherein the step of applying the coating material to the woven substrate further comprises mechanically disrupting the orientation of the yarns upon the vent, thereby facilitating gas permeability of the vent.

10. The method of claim 8 wherein said woven airbag is a one piece woven airbag.

11. An airbag made according to the method of claim 8.

12. A one-piece woven airbag made according to the method of claim 10.

13. The airbag of claim 11 wherein the coating material comprises a silicone copolymer or polymer.
